(19) United States
(12) Patent Application Publication
(10) Pub. No.: US 2018/0276457 A1
(43) Pub. Date: Sep. 27, 2018

(54) Systems and Methods of Activation of 4D Effects Based on Seat Occupancy

(71) Applicant: MediaMation, Inc., Torrance, CA (US)

(72) Inventors: Daniel Robert Jamele, Palos Verdes Estates, CA (US); David Taylor, Rolling Hills, CA (US); Mike Ridderhof, Long Beach, CA (US); Hunter Grayson, Westminster, CA (US)

(21) Appl. No.: 15/469,738

(22) Filed: Mar. 27, 2017

(51) Int. Cl. G06K 9/00; H04N 5/33; G06T 7/11; G06T 5/50; H04N 5/232; H04N 5/225; A63J 5/00; A47C 1/12

(52) U.S. Cl. CPC G06K 9/00362; H04N 5/332; G06T 7/11; G06T 5/50; H04N 5/23296; H04N 5/2258; A63J 2005/003; A47C 1/12; G06T 2210/12; G06T 2207/20224; G06T 2207/10048; G06T 2207/30196; A63J 2005/002; A63J 5/00

(57) ABSTRACT

The invention relates to a system to activate 4D effects for occupants in seats, including a thermal camera to capture a thermal image of the 4D seats, and a server to determine the occupancy of the 4D seats from the thermal image and to control the 4D seats. It also relates to a method of activate 4D effects based on seat occupancy, including receiving a baseline thermal image of seats, defining a bounding box in the baseline thermal image of the seats, storing the bounding box and the baseline thermal image, acquiring an occupancy thermal image of the seats, removing the baseline thermal image from the occupancy thermal image, locating people in the occupancy thermal image, determining occupancy of the seats, and activating the effects based on seat occupancy.

### BACKGROUND

The invention relates to systems and methods for activation of 4D effects based on seat occupancy.

Disney's Star Tours and Universal Studio's The Simpsons Ride, commercial movie theaters, gaming environments, and training centers (e.g., military, law enforcement, and flight schools) use 4D effects to produce the sensation that one is immersed in the reality displayed on a movie screen.

Seat motion is an example of a 4D effect. It can be implemented by synchronizing the seat motion of the viewer to correspond to the displayed scenes. The motion seat systems can be adapted to receive motion signals that move seats to correspond (e.g., synchronize) to other signals (e.g., video and/or audio signals) that are perceived by person(s). For example, the seat system may synchronize seat motions with the displayed motions in a theater to simulate the forces one would experience seated in a vehicle in a chase scene where the vehicle races around a city street. U.S. Pat. No. 8,585,142 B2 to Jamele et. al., assigned to MediaMation, Inc. describes suitable seat systems to implement 4D effects. Fluid delivery to the seat is another 4D effect. A fluid delivery can be used to deliver fluids such as a water mist, a blast of air, wind, and one or more scents to the viewer with the displayed scenes. For example, a system may deliver an orange scent to the viewer while movie displays a character traveling through an orange orchard, deliver a water mist to the viewer when the character travels through a rainy jungle or wind in a storm scene. U.S. Pat. No. 9,307,841 B2 to Jamele et al., and U.S. application Ser. No. 14/935,334 to Jamele et al., all assigned to MediaMation, Inc., describe suitable fluid delivery systems to implement 4D effects.

### SUMMARY OF THE INVENTION

In a feature of the invention, a system for activation of 4D effects based on seat occupancy, including a camera unit to determine the occupancy of the 4D seats, wherein the camera unit includes a thermal camera to capture thermal images of the 4D seats, a visible light camera to capture a visible light image of the 4D seats, and a computer adapted to construct bounding boxes that correspond to the 4D seats and determine the occupancy of the 4D seats from the thermal images, and a mechanism to align the camera unit to define a field of view of the 4D seats and a server adapted to communicate with the computer of the camera unit and activate 4D effects at the occupied 4D seats.

In another feature of the invention, a system is used for activation of 4D effects based on seat occupancy, including a camera unit to determine the occupancy of the 4D seats, wherein the camera unit includes a thermal camera to capture thermal images of the 4D seats, and a computer adapted to construct bounding boxes that correspond to the 4D seats and determine the occupancy of the 4D seats from the thermal images, and a mechanism to align the camera unit to define a field of view of the 4D seat, and a server adapted to communicate with the computer of the camera unit and activate 4D effects at the occupied 4D seats.

In another feature of invention, a system issued to selectively activates 4D effects based on determination of occupants in seats, including a visible light camera to capture an initial image of the seats, a thermal camera to capture an initial image of the occupants in the seats, a computer that receives the seat image and the occupant image and relates the seat image with the occupant image to determine where the seats have occupant(s), and periodically reads the collocated image and transmit an activation signal to an actuator of each 4D seat with an occupant and/or a deactivation signal to an actuator of each 4D seat without an occupant.

In another feature of the invention, a system is used to activate 4D effects for occupants in seats, including a thermal camera to capture thermal images of the 4D seats, and a server to determine the occupancy of the 4D seats from the thermal images and to control the 4D seats.

In another feature of the invention, a method is used to activate 4D effects based on 4D seat occupancy, comprising the steps of:
(a) receiving a baseline thermal image of 4D seats;
(b) receiving a visible light image of the 4D seats;
(c) defining a bounding box in the baseline thermal image of the 4D seats;
(d) transferring the bounding box to the baseline thermal image;
(e) storing the bounding box and the baseline thermal image;
(f) acquiring an occupancy thermal image of the 4D seats;
(g) removing the baseline thermal image from the occupancy thermal image;
(h) locating people in the occupancy thermal image;
(i) determining occupancy of the 4D seats; and
(j) activating the 4D seating based on the occupancy of the 4D seats.

In another feature of the invention, a method is used to activate 4D effects based on 4D seat occupancy, comprising the steps of:
(a) receiving a baseline thermal image of 4D seats;
(b) defining a bounding box in the baseline thermal image of the 4D seats;
(c) storing the bounding box and the baseline thermal image;
(d) acquiring an occupancy thermal image of the 4D seats;
(e) removing the baseline thermal image from the occupancy thermal image;
(f) locating people in the occupancy thermal image;
(g) determining occupancy of the 4D seats; and
(h) activating the 4D seating based on the occupancy of the 4D seats.

### BRIEF DESCRIPTION OF THE DRAWINGS

FIG. 1 illustrates an embodiment of a theatre with a camera unit adjacent a movie screen to capture an image of occupancy in 4D seats.

FIG. 2A illustrates a visible light camera view of 4D seats in a theatre and bounding boxes showing the location of the 4D seats.

FIG. 2B illustrates a thermal camera view of the 4D seats with bounding boxes that correspond to the bounding boxes of FIG. 2A.

FIG. 3 illustrates an occupant in a 4D seat and vacant seat in the thermal image

FIG. 4 illustrates hardware architecture of an embodiment of the system.

FIG. 5 illustrates a method of determining occupancy in the 4D seating.

FIG. 6 illustrates hardware architecture of another embodiment of the system.

### DETAILED DESCRIPTION OF THE PREFERRED EMBODIMENTS

The following description includes the best mode of carrying out the invention. The detailed description illustrates the principles of the invention and should not be taken in a limiting sense. The scope of the invention is determined by reference to the claims. Each part (or step) is assigned its own part (or step) number throughout the specification and drawings. The method drawings illustrate a specific sequence of steps, but the steps can be performed in parallel and/or in different sequence to achieve the same result.

It is recognized that 4D effects produce a more realistic experience in a theater or amusement park, but each 4D effect expends resources, e.g., electrical power for motion seat(s) or delivery of fluid (e.g., mist, air), while in operation. In various embodiments, a system use a camera unit including (1) a thermal camera, or (2) a thermal camera and visible camera with a server to determine location of occupants in 4D seats and selectively activate and deactivate seat motion and/or fluid delivery based when a given seat is occupied to reduce electrical power and fluid consumption used for the 4D effects.

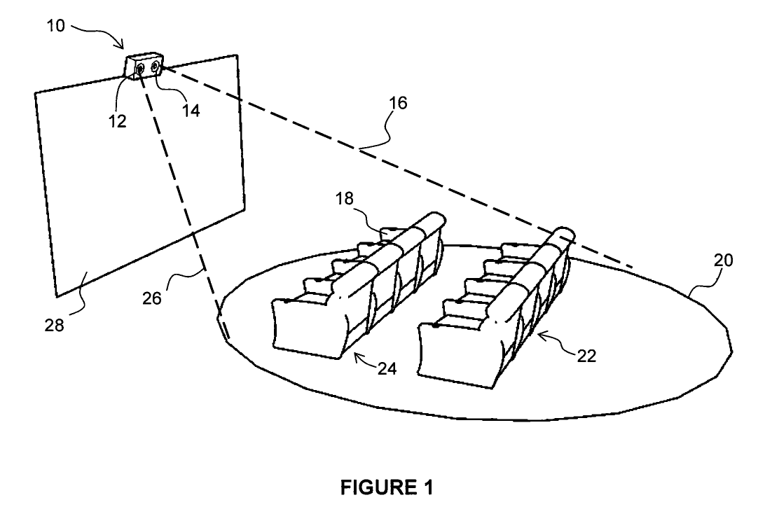

FIG. 1 illustrates an embodiment of a movie theatre with a camera unit above the movie screen to capture an image of occupancy in 4D seating. As shown, a camera unit 10 includes a visible light camera 12 and a thermal camera 14 that are located adjacent (e.g., above) to a movie screen 28. The camera unit 10 includes a mechanism (not shown) that attached to the wall adjacent the movie screen 28. The mechanism can be fixed or permit adjustments as long as the visible light camera 12 and the thermal camera 14 in camera unit 10 are aligned to capture an image of the 4D seats. FIG. 1 illustrates that camera unit 10 that is aligned to capture 4D seat systems 22 and 24 within field of view 20 with edges 16 and 26.

In an embodiment, a suitable visible light camera is Sony Exmor IMX219 Sensor, part RPI-CAM-V2, made in China, available through contacting the Raspberry Pi Foundation, Cambridge, England. A suitable thermal camera is Lepton, 80x60, 50 degree, part 500-0763-01, from FLIR Systems, Wilsonville, Oreg. In an embodiment, the visible light camera and the thermal camera both have a 50 degree lens and are mounted one inch apart in the camera unit. By downsizing the visible light image to match the thermal image, the field of views are aligned within 1-2 pixels accuracy. A suitable computer is the system on board, part Raspberry PI-MODB-1GB, a Linux based system available by contacting the Raspberry Pi Foundation. A suitable data storage for the camera unit 10 is the SanDisk 16 GB micro SD card, such as part SDSDQM016GBB35A, available from SanDisk, Sunnyvale, Calif., acquired by Western Digital, Irvine, Calif. A suitable data breakout board for the thermal camera is the Lepton Breakout v1.4, manufactured by FLIR Systems in Wilsonville, Oreg. The I2C protocol is used for communications between the data breakout board and the thermal camera.

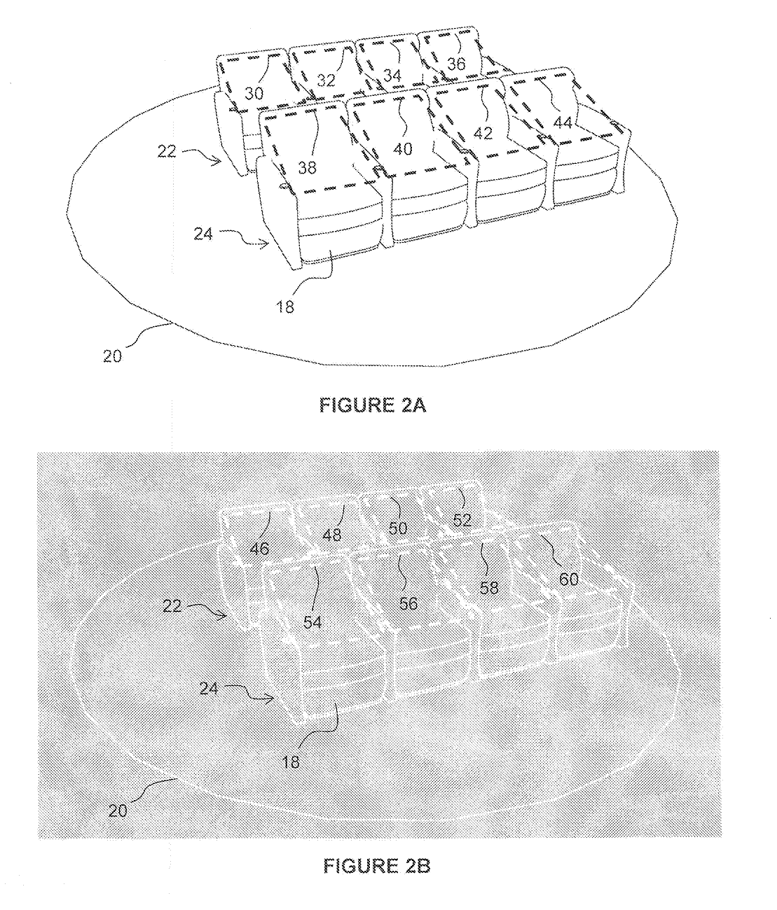

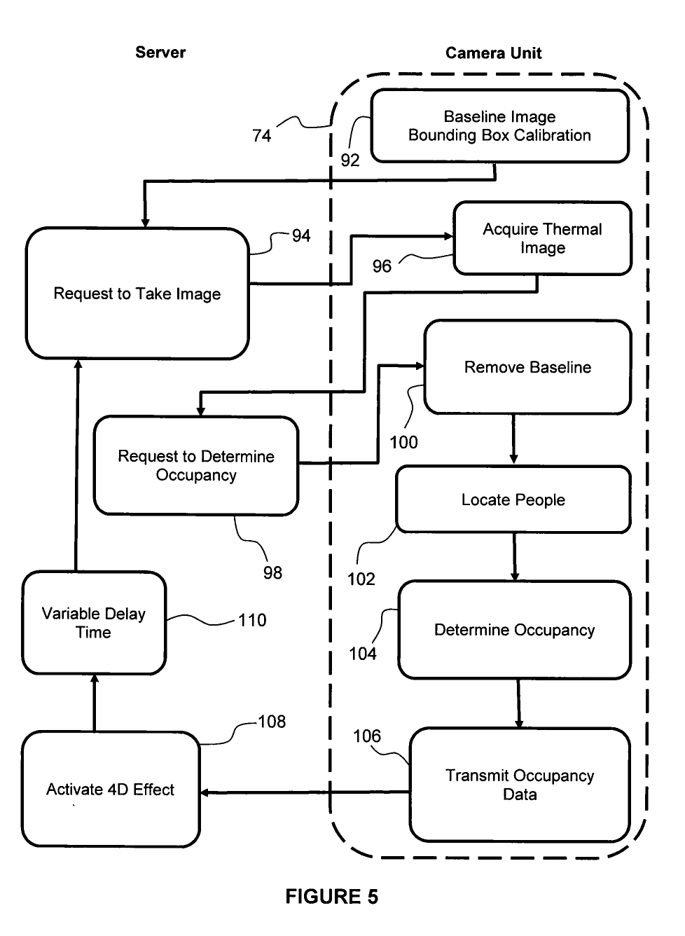

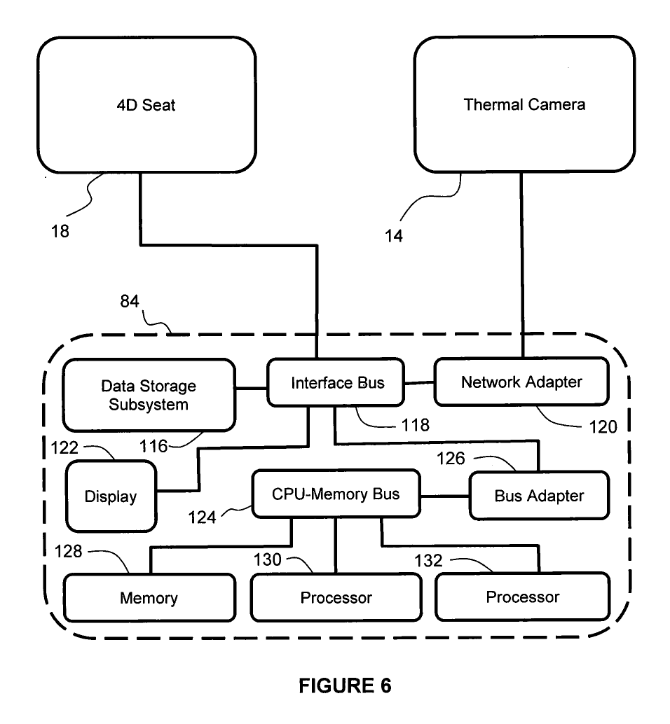

FIG. 2A illustrates a visible light camera view of the 4D seats in the theatre of FIG. 1. As shown a visible light camera 12 (FIG. 1) has a field of view 20 that captures an image of the 4D seat systems 22 and 24 including a representative seat 18. After capturing the visible light image, the operator disables the visible light camera to save electrical power and address any privacy and intellectual property. A computer 74 (FIGS. 5-6) permits an operator to initiate calibration of the system by constructing bounding boxes 38, 40, 42, and 44 for the 4D seat system 24 and bounding boxes 30, 32, 34, and 36 for the 4D seat system 22. The computer 74 includes an input device (e.g., keyboard, trackpad, or mouse) that permits the operator to construct the bounding boxes, e.g., by clicking on the four corners of the bounding box or by inputting x-y coordinates for each corner of the bounding box.

FIG. 2B illustrates a thermal camera view of the 4D seats in the theatre of FIG. 1. As shown, a thermal camera 14 (FIG. 1) has a field of view 20 that captures a thermal image of the 4D seat systems 22 and 24. With or without operator input, the computer 74 transfers bounding boxes such as 54, 56, 58, and 60 that correspond to boxes 38, 40, 42, and 44 shown in FIG. 2A to the thermal image shown in FIG. 2B. In an embodiment, the visible light image is down-sampled to match the resolution of the thermal image. After the bounding boxes are defined in the visible light image, those regions are then transferred onto the thermal image in 1:1 correspondence.

Similarly, the computer transfers bounding boxes such as 30, 32, 34, and 36 that correspond to boxes 38, 40, 42, and 44 shown in FIG. 2A to the thermal image shown in FIG. 2B. The transferred bounding box permits the operator to see where the seats are located and whether or not a given 4D seat in the 4D seat system is occupied or vacant.

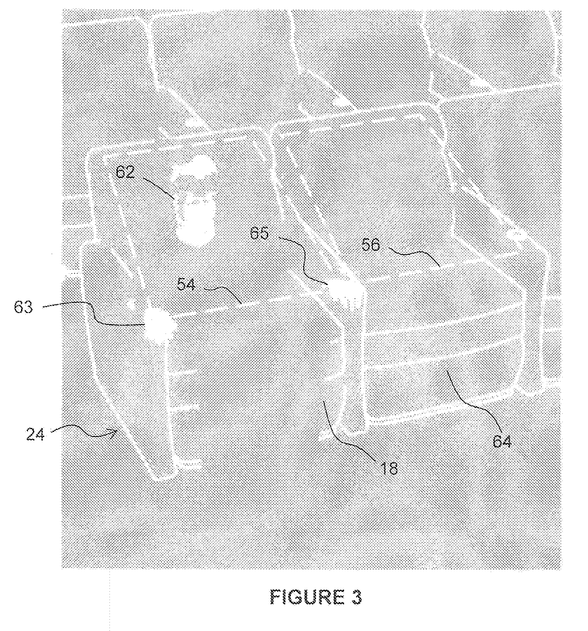

For example, FIG. 3 is a thermal image that shows an occupant in a 4D seat and a vacant seat. Because the bounding box 54 corresponds to the location of the seat 18, the computer 74 can determine from the thermal image (e.g., head 62 and hands 63, 65) within the bounding box 54 that a viewer is occupying seat 18. Conversely, because the bounding box 56 corresponds to the location of seat 64, the computer 74 can determine seat 64 is not occupied or vacant.

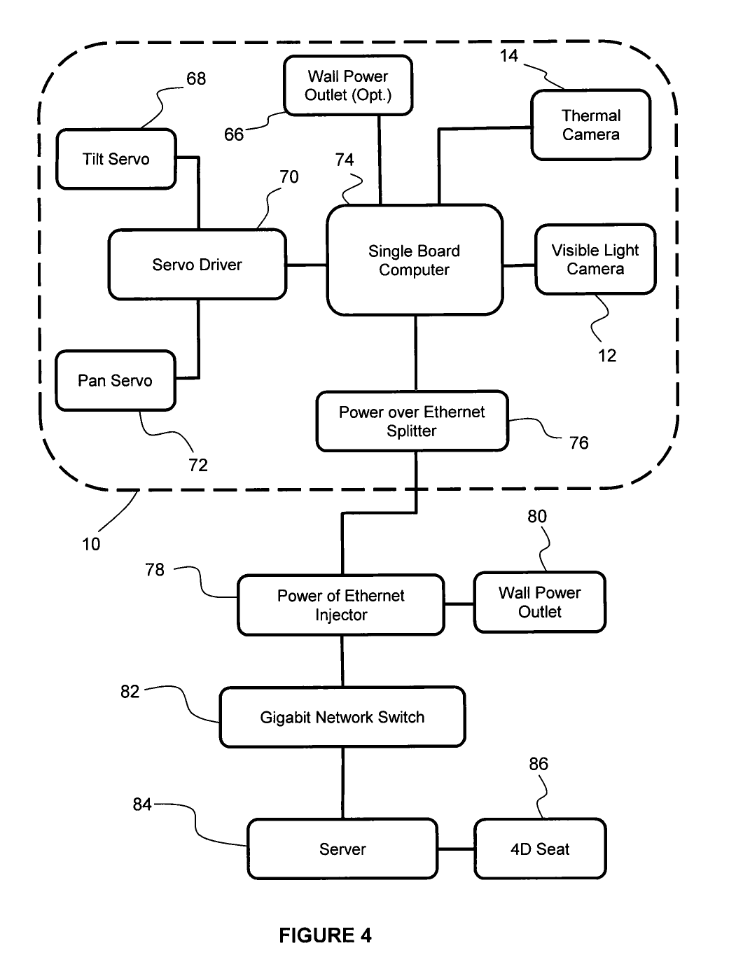

FIG. 4 illustrates a hardware architecture of an embodiment of the system. As shown, a camera unit 10 communicates with a server 84 (FIG. 6) through a power over Ethernet injector 78 and a Gigabit network switch 82. The power over Ethernet injector 78 receives electrical power through a wall power outlet 80. The server 84 also communicates with a 4D seat 86. As shown, the camera unit 10 includes a mechanism adapted to align the camera unit 10 to capture the 4D seats. In an embodiment, the mechanism uses a servo driver 70 adapted to communicate with the single board computer 74, a tilt servo 68 and a pan servo 72 to align camera unit 10. In an embodiment, the computer 74 is powered by the power over Ethernet splitter 76. In another embodiment, the computer 74 receives electrical power through wall power outlet 66. In addition, the computer 74 communicates with a thermal camera 14 and a visible light camera 12. In an embodiment, the system just described and illustrated in FIG. 4 uses the same parts as described in the specification accompanying FIG. 1. The camera unit 10 communicates with the server 84 through a conventional power over Ethernet cable. The visible light camera 12 and thermal camera 14 are aligned such that they have same field of view as shown in FIG. 1. The server 84 communicates with the 4D seat 86 (e.g., one seat or more) to selectively activate and deactivate seat motion and/or fluid delivery to the 4D seat 86 is occupied to reduce electrical power and fluid consumption used for the 4D effects.

FIG. 5 illustrates a method of determining occupancy in the 4D seating. As shown, the method is implemented on a server (e.g., server 84) and a computer (e.g., single board computer 74) in the camera unit 10. As shown, the method of activates 4D effects based on 4D seat occupancy. At a calibrating step 92, the computer receives a baseline thermal image of 4D seats, a visible light image of the 4D seats, defines a bounding box in the baseline thermal image of the 4D seats, and transfers the bounding box to the baseline thermal image, storing the bounding box and the baseline thermal image. At step 94, the server requests the camera unit to take thermal image. At step 96, the camera unit acquires a thermal image. At step 98, the server requests the camera unit to determine seat occupancy. At step 100, the computer of the camera unit removes the thermal baseline image from the acquired thermal image. At step 102, the computer of the camera unit locates the people in the acquired thermal image. At step 104, the computer of the camera unit determines seat occupancy within the acquired thermal image. At step 106, the computer of the camera unit transmits the occupancy data to the server to activate 4D effects at step 108. At step 110, the server waits a variable delay (e.g. 5 minutes) then proceeds to step 94 to repeat the method. In another embodiment, the method executes the same steps of FIG. 5, except that step 92 is implemented by receiving a baseline thermal image of 4D seats, defining a bounding box in the baseline thermal image of the 4D seats, and storing the bounding box and the baseline thermal image.

FIG. 6 illustrates hardware architecture of another embodiment of the system. As shown, a server 84 is adapted to execute the methods (e.g., software) as described in FIG. 5, and to communicate with the thermal camera 14 and the 4D seat 18. A suitable thermal camera is FLIR Boson™, 50 degree, 20320H050-9PAAX, from FLIR Systems, Wilsonville, Oreg. Hennessy and Patterson, Computer Architecture: A Quantitative Approach (2012), and Patterson and Hennessy, Computer Organization and Design: The Hardware/Software Interface (2013) describe computer hardware and software, storage systems, caching, and networks and are incorporated by reference.

As shown in FIG. 6, the server 84 includes a motherboard with a CPU-memory bus 124 that communicates with dual processors 130 and 132. The processor used is not essential to the invention and could be any suitable processor such as the Intel Pentium processor. A processor could be any suitable general purpose processor running software, an ASIC dedicated to perform the operations described herein or a field programmable gate array (FPGA). Also, one could implement the invention using a single processor in each host or more than two processors to meet various performance requirements. The arrangement of the processors is not essential to the invention. Data is defined as including user data, instructions, and metadata. Inputting data is defined as the input of parameters and data from user input, computer memory, and/or storage device(s). The processor 130 and/or 132 read and write data to and from the memory 128 and/or a data storage subsystem 116. The server 84 includes a bus adapter 126 between the CPU-memory bus 124 and an interface bus 118. The interface bus 118 communicates with a display 122 and the 4D seat 18. A non-transitory computer-readable medium (e.g., storage device, CD, DVD, floppy disk, USB storage device) can be used to encode the software program instructions described in the methods below.

Each host runs an operating system such as the Apple OS, Linux, UNIX, a Windows OS, or another suitable operating system. Tanenbaum et al., Modern Operating Systems (2014) describes operating systems in detail and is incorporated by reference herein. Bovet and Cesati, Understanding the Linux Kernel (2005), describe operating systems in detail and is incorporated by reference herein.

The server 84 communicates through the network adapter 120 to the thermal camera 14. The communication links between server 84, thermal camera 14, and the 4D seat 18 can be implemented using a bus, SAN, LAN, or WAN technology such as Fibre Channel, SCSI, InfiniBand, or Ethernet.

What is claimed:

1. A system for activation of 4D effects based on seat occupancy, comprising:
a camera unit to determine the occupancy of the 4D seats, wherein the camera unit includes a thermal camera to capture thermal images of the 4D seats, a visible light camera to capture a visible light image of the 4D seats, and a computer adapted to construct bounding boxes that correspond to the 4D seats and determine the occupancy of the 4D seats from the thermal images, and a mechanism to align the camera unit to define a field of view of the 4D seats; and
a server adapted to communicate with the computer of the camera unit and activate 4D effects at the occupied 4D seats.

2. The system of claim 1, wherein the computer subtracts a baseline thermal image from an occupancy thermal image of the 4D seats.

3. The system of claim 1, wherein the mechanism includes a servo driver adapted to communicate with the computer, a tilt servo and a pan servo that are adapted to align the camera unit to capture the 4D seats.

4. The system of claim 1, wherein the server and the camera unit communicate through a power over Ethernet cable.

5. The system of claim 1, wherein the visible light camera and thermal camera are aligned such that they have same field of view.

6. The system of claim 1, wherein the server selectively activates and deactivates seat motion and/or fluid delivery based when a given seat is occupied to reduce electrical power and fluid consumption used for the 4D effects.

7. A method of activating 4D effects based on 4D seat occupancy, comprising the steps of:
(a) receiving a baseline thermal image of 4D seats;
(b) receiving a visible light image of the 4D seats;
(c) defining a bounding box in the baseline thermal image of the 4D seats;
(d) transferring the bounding box to the baseline thermal image;
(e) storing the bounding box and the baseline thermal image;
(f) acquiring an occupancy thermal image of the 4D seats;
(g) removing the baseline thermal image from the occupancy thermal image;
(h) locating people in the occupancy thermal image;
(i) determining occupancy of the 4D seats; and
(j) activating the 4D seating based on the occupancy of the 4D seats.

8. The method of claim 7, further comprising a step (k) waiting a delay time; and (I) repeating steps (f)-(k).

9. The method of claim 7, wherein step (h) is implemented by using computer vision.

10. The method of claim 9, wherein the computer vision includes blob detection or similarity detection.

11. The method of claim 7, wherein the step (i) determining occupancy o the 4D seats is implemented by measuring the relative position between a person and the bounding box.

12. A system for activation of 4D effects based on seat occupancy, comprising:
a camera unit to determine the occupancy of the 4D seats, wherein the camera unit includes a thermal camera to capture thermal images of the 4D seats, and a computer adapted to construct bounding boxes that correspond to the 4D seats and determine the occupancy of the 4D seats from the thermal images, and a mechanism to align the camera unit to define a field of view of the 4D seat; and
a server adapted to communicate with the computer of the camera unit and activate 4D effects at the occupied 4D seats.

13. The system of claim 12, wherein the server subtracts a baseline thermal image from an occupancy thermal image of the 4D seats.

14. The system of claim 12, wherein the mechanism includes a servo driver adapted to communicate with the server, a tilt servo and a pan servo that are adapted to align the camera unit to capture the 4D seats.

15. The system of claim 1, wherein the server and the camera unit communicate through Wi-Fi.

16. The system of claim 1, wherein the server selectively activates and deactivates seat motion and/or fluid delivery based when a given seat is occupied to reduce electrical power and fluid consumption used for the 4D effects.

17. A method of activate 4D effects based on 4D seat occupancy, comprising the steps of:
(a) receiving a baseline thermal image of 4D seats;
(b) defining a bounding box in the baseline thermal image of the 4D seats;
(c) storing the bounding box and the baseline thermal image;
(d) acquiring an occupancy thermal image of the 4D seats;
(e) removing the baseline thermal image from the occupancy thermal image;
(f) locating people in the occupancy thermal image;
(g) determining occupancy of the 4D seats; and
(h) activating the 4D seating based on the occupancy of the 4D seats.

18. The method of claim 17, further comprising a step (i) waiting a delay time; and (j) repeating steps (d)-(i).

19. The method of claim 17, wherein step (f) is implemented by using computer vision.

20. The method of claim 19, wherein the computer vision includes blob detection or similarity detection.

21. The method of claim 17, wherein the step (g) determining occupancy of the 4D seats is implemented by measuring the relative position between a person and the bounding box.
